(19) United States
(12) Patent Application Publication
(10) Pub. No.: US 2007/0169114 A1
(43) Pub. Date: Jul. 19, 2007

(54) Application suite installer with automatic detection of content and configurable options

(75) Inventors: Jesper Kenneth Birk Olsen, Kirkland, WA (US); Benjamin Liu, Seattle, WA (US); Soren Francker, Kirkland, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/270,043

(22) Filed: Nov. 9, 2005

(51) Int. Cl. G06F 9/445

(52) U.S. Cl. 717/174

(57) ABSTRACT

An application suite installation framework comprises an application suite installer program, an installation configuration file, and the program files and other contents that comprise the software applications. The installation configuration file contains an entry for each software application which is available for installation. The application suite installer program contains the logic to read the installation configuration file to determine the installation options to display, and displays the installation options to a user. For each of the software applications in the list that is selected by the user, the application suite installer program installs the software application using the information, including an application installer, specified in the entry corresponding to that software application in the installation configuration file.

### BACKGROUND

A continually increasing number of software applications are being made available for use on computer systems. Before a user can use a software application, the software application first needs to be installed and configured on the computer system. A typical software application installation involves a transfer of the files that comprise the software application onto the computer system, and the configuration of the software application and various components of the computer system to recognize and interact with each other. For example, the configuration of the computer system may include the addition or modification of registry settings, the configuration of one or more device drivers, and the configuration of operating system settings, etc.

Increasing numbers of software applications are now being provided as part of a bundle or suite of applications. An application suite is a set of software applications that are designed to work together, and are typically provided on one CD-ROM. For example, a suite of applications may include a word processing application, a spreadsheet application, a presentation application, and an email application. In many instances, an installation program, such as a “wizard,” that can be used to install and configure some or all of the software applications is also provided with the suite of applications on the CD-ROM. Typically, the installation wizard presents to a user a series pages through which the user provides requested input, such as a selection of the desired software applications in the suite of applications, and other responses. The installation wizard uses the received responses to install and configure the selected software applications onto the user's computer system.

A difficulty with conventional installation programs is their inflexibility. The inflexibility arises because the knowledge of the software applications that are available for installation and the installation process is hard-coded or built-in to the installation program. For example, an installation program that is provided with a suite of applications comprising software applications A, B, and C is only capable of installing these applications. When the contents of the suite of applications is altered in any manner, for example, when another software application D is added to the suite of applications, the originally provided installation program will not be able to install and/or configure the newly added software application D. Whenever a new software application is added to a suite of applications, the installation program originally provided with the suite of applications will need to be changed and rebuilt to handle the installation of the new software application.

Another difficulty with conventional installation programs is that the installation program typically has a predefined set of user interfaces or pages that are presented to a user during the installation process. The predefined set of pages may not, however, cover all installation scenarios that may arise during the installation of a software application. In order to add an additional page that addresses an installation scenario, the installation program will need to be changed and rebuilt to include the additional page.

### SUMMARY

An application suite installation framework is provided. The framework comprises an application suite installer program, an installation configuration file, and the program files and other contents that comprise the software applications. The installation configuration file contains an entry for each software application which is available for installation. The application suite installer program contains the logic to read the installation configuration file to determine the installation options to display, and displays the installation options to a user. For each of the software applications in the list that is selected by the user, the application suite installer program installs the software application using the information, including an application installer, specified in the entry corresponding to that software application in the installation configuration file.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is block diagram illustrating components of an application suite installation framework, according to some embodiments.

FIG. 2 illustrates selected contents of an example installation configuration file, according to some embodiments.

FIG. 3 is a flow diagram that illustrates the processing of an application suite installer program, according to some embodiments.

### DETAILED DESCRIPTION

An application suite installation framework is provided. In some embodiments, the framework comprises an application suite installer program, an installation configuration file, and the program files and other contents that comprise the software applications. The installation configuration file contains an entry for each software application, such as the software applications in an application suite, which is available for installation. The application suite installer program, such as an installation wizard, contains the logic to read the installation configuration file to determine the installation options to display, for example, to a user. For example, the installation wizard can display on a page a list of the software applications that can be selected for installation. For each of the software applications in the list that is selected by the user, the application suite installer program reads the entry corresponding to the software application in the installation configuration file and identifies an application installer to use in installing the particular software application. The application suite installer program installs the particular software application by invoking or launching the identified application installer. In a similar manner, the application suite installer program installs the other software applications which were selected by the user to be installed. By maintaining the information that is necessary to install a software application in the installation configuration file that is separate from the application suite installer program, the framework provides a mechanism whereby the contents of the application suite may be altered without impacting the application suite installer program. To add a new software application to the application suite and have the application suite installer program support the new software application, an application developer can create an entry for the new software application in the installation configuration file. The application developer does not need to change the logic of the application suite installer program.

In some embodiments, an entry for a software application in the installation configuration file may specify an additional page (e.g., a custom page or Ul) that is to be displayed by the application suite installer program. This allows the application installer corresponding to the software application to add a page or multiple pages to the application installer program, and use the added page to expose a custom option, such as an option to uninstall previous versions of the software application, to the user. To add the additional page, an application developer can specify as part of the entry in the installation configuration file for the software application a procedure (e.g., method, property, etc.) that returns the additional page, and does not need to change the logic of the application suite installer program.

In some embodiments, the application suite installer program provides “hooks” that allows an application installer for a software application identified in the installation configuration file to run or execute a prerequisites, preinstall, and postinstall actions in three methods that are called by the application suite installer program at the appropriate times. The prerequisites specify the minimum requirements (e.g., required file space, CPU type and speed, components, etc.) that are necessary for the software application to install and run on the computer system. The preinstall actions specify the actions that need to be performed on the computer system (e.g., cleaning up file, uninstalling older versions of the software application, uninstalling incompatible software applications, reconfiguring devices, etc.) prior to installing the software application. The post install actions specify the actions that need to be performed on the computer system (e.g., setting up user accounts, setting up integration between components, etc.) after installing the software application. The application installer provides its own logic, and the application suite installer program calls the provided logic. To add the hooks, an application developer can specify as part of the entry in the installation configuration file for the software application a path to a “prerequisites” method, a “preinstall” method, and a “postinstall” method, where each of the methods contains the logic that performs the respective actions. The application suite installer program then calls the provided methods in sequence during the installation of the software application (e.g., first the prerequisites method, and if the specified prerequisites are satisfied, then the preinstall method, and subsequent to successfully installing the software application, the postinstall method). One skilled in the art will appreciate that one or more of the hooks (e.g., methods) may not be provided or may invoke logic that simply returns without performing any checks or actions on the computer system. For example, some software applications may not need to perform any prerequisite checks, preinstall actions and/or postinstall actions.

In some embodiments, an entry for a software application in the installation configuration file may specify one or more launch parameters to be used with the specified application installer for the software application. The launch parameters are software application-specific parameters, and are used by the application suite installer program in launching the application installer. An application developer can specify the launch parameters as part of the entry in the installation configuration file for the software application.

In some embodiments, an entry for a software application in the installation configuration file may include an indication that specifies whether the software application is a required application (or component). If the software application is a required component, the application suite installer program indicates that the software application is required in the displayed list of software applications that can be selected for installation. The application suite installer program does not provide the user the ability to omit or deselect the software application from being installed. An application developer can indicate whether a software application is required to be installed as part of the entry in the installation configuration file for the software application.

In some embodiments, an entry for a software application in the installation configuration file may specify a key, such as a registry key, that identifies the software application. For example, when the software application is installed on the computer system, the specified key is placed in a product registry on the computer system. This allows the application suite installer program to use the key to determine whether the software application is already installed on the computer system. If the specified key is present in the product registry, the application suite installer program can determine that the software application is already installed. If the software application is already installed, the application suite installer program may indicate that the software application is not available for selection by “graying out” the entry for the software application in the displayed list of software applications that can be selected for installation. An application developer can specify the key as part of the entry in the installation configuration file for the software application.

In some embodiments, an entry for a software application in the installation configuration file may specify an install path. The install path specifies the location where the software application is installed. An application developer can specify a variable or placeholder for the install path as part of the entry in the installation configuration file for the software application. When the software application is installed on the computer system, the application suite installer program may replace the variable with an indication of the location where the software application was installed. In some embodiments, the install path may be used to ensure that the software applications in an application suite are installed at the same location. This allows the software applications in an application suite that were not previously installed to be installed in the same location as the other software applications in the application suite which were previously installed.

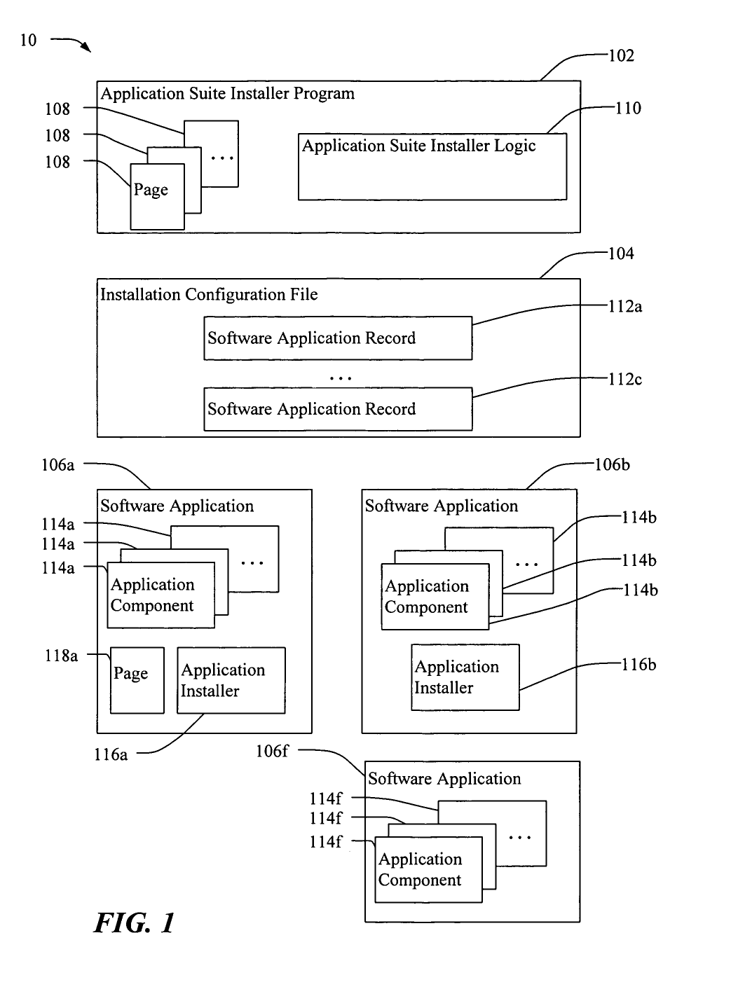

FIG. 1 is block diagram illustrating components of an application suite installation framework 10, according to some embodiments. As depicted, the application suite installer framework comprises an application suite installer program 102, an installation configuration file 104, and one or more software applications, for example, software applications 106a-f. While the framework in FIG. 1 is shown as including six software applications, one skilled in the art will appreciate that there may be a different number of software applications, and the number of software applications depends on, for example, the number of software applications that are available for creating suites of applications.

In general terms, the application suite installer program is a tool that enables the installation of one or more software applications onto, for example, a computer system. In some embodiments, the application suite installer program may be implemented as a wizard comprising a plurality of pages 108 and application suite installer logic 110. The pages are the Uls that are displayed to the user during the installation process. The application suite installer logic reads the installation configuration file, and controlling the plurality of pages, facilitates the installation of one or more software applications based on the contents of the installation configuration file. One skilled in the art will appreciate that the application suite installer program need not be implemented as a wizard, but may be implemented using any of a variety of well-known programming and interface techniques to enable installation of software applications based on the contents of the installation configuration file.

The installation configuration file contains the information regarding the software applications that are in an application suite and available for installation, for example, by the application suite installer program. For example, assuming the application suite is provided on a CD-ROM, the installation configuration file contains the information regarding the software applications and components that are on the CD-ROM. As depicted in FIG. 1, the installation configuration file comprises a plurality of software application records 112a-c. Each software application record corresponds to a software application that is identified in the installation configuration file, and provides the information regarding that software application. For example, an application developer can create a software application record for a software application, and the software application record can be included in the installation configuration file to create an entry in the installation configuration file for that software application.

The software applications are the applications that are available to create the application suites. As depicted in FIG. 1, software application 106a comprises a plurality of application components 114a, an application installer 116a, and a custom page 118a; software application 106b comprises a plurality of application components 114b and an application installer 116b; and software application 106f comprises a plurality of application components 114f. The application components are the components (e.g., executables, data files, configuration files, etc.) that make up the particular software application. The application installer is an application-specific installation program. For example, a software application may need to be installed using a special installation program that is designed to install the software application. In this case, an application developer may provide the application-specific installation program with the software application. If a software application can be installed using a “generic” installation program, such as the installation program provided with the operating system (OS) that is executing on the computer system on which the installation is to take place, an application-specific installation program need not be provided with the software application. By way of example and as illustrated in FIG. 1, software applications 106a and 106b are each shown as providing respective application-specific application installers 106a and 106b. The custom page is specific to the installation of a software application, and is displayed to the user during the installation of that software application. For example, the custom page can expose a custom option that is specific to the installation of the software application to the user. By way of example and as illustrated in FIG. 1, software application 106a is shown as having a custom page 118a.

The application suite installation framework provides organizations, such as software application providers who provide software applications the ability to segment the market by developing different suites of applications without impacting the application suite installer logic for installing the software applications in the different application suites. For example, when the application developer develops a software application, the application developer can also create the code “snippet” for the software application (e.g., the contents of the software application record) that is to be included in the installation configuration file. Within the organization, each of the developed and available software applications will have corresponding code snippets that are to be included in the installation configuration file. The organization is then able to easily create different application suites comprised of one or more of the available software applications. For example, to create an application suite made up of software applications A, B, and C, the organization creates an installation configuration file that contains the code snippets for software applications A, B, and C. The organization then places the application suite installer program, the created installation configuration file, and the software applications A, B, and C (e.g., the application files and components) on removable storage media, such as CD-ROMs, DVDs, flash drives, etc., for consumption by users. To create a different application suite, the organization need only create a new installation configuration file that includes the code snippets for the software applications desired in the new application suite. The organization can then place the same application suite installer program, the newly created installation configuration file, and the components of the software applications to include in the new application suite on removable storage media for consumption by users. In this way, the framework allows an organization to quickly and easily create suites of applications without having to create and test installation programs for each application suites.

In some embodiments, the application suite installer program, the installation configuration file, and the software applications that are contained in the application suite are provided on a removable storage media, such as a removable disk. In other embodiments, the application suite installer program, the installation configuration file, and the software applications that are contained in the application suite may be provided for distribution by a web service. For example, the application suite installer program, the installation configuration file, and the software applications that are contained in the application suite may be provided at a network location, such as a web server. To install one or more software applications from a web service, a user can use a computer system to access the web server and download and execute the application suite installer program on the computer system. In still other embodiments, the application suite installer program, the installation configuration file, and the software applications that are contained in the application suite may be provided in a distributed fashion. For example, the application suite installer program and the installation configuration file may be provided on a CD-ROM, and the software applications that are identified in the installation configuration file, and which can be installed using the application suite installer program, may be provided at a web server.

In some embodiments, a web server may provide a list of possible software applications that are available for installation on, for example, a user's computer system. The user can then select one or more of the software applications in the list and request the web server to install the selected software applications on the user's computer system. In response, the web server can generate an installation configuration file based on the user's selection of software applications. An application suite installer program can then use the created installation configuration file to install the selected software applications on the user's computer. In one embodiment, the application suite installer program may execute on the web server. In another embodiment, the application suite installer program may execute off of a CD-ROM loaded onto the user's computer system.

The computing devices on which the framework is implemented may include a central processing unit, memory, input devices (e.g., keyboard and pointing devices), output devices (e.g., display devices), and storage devices (e.g., disk drives). The memory and storage devices are computer-readable media that may contain instructions that implement the framework. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on.

Embodiments of the framework may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The framework may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

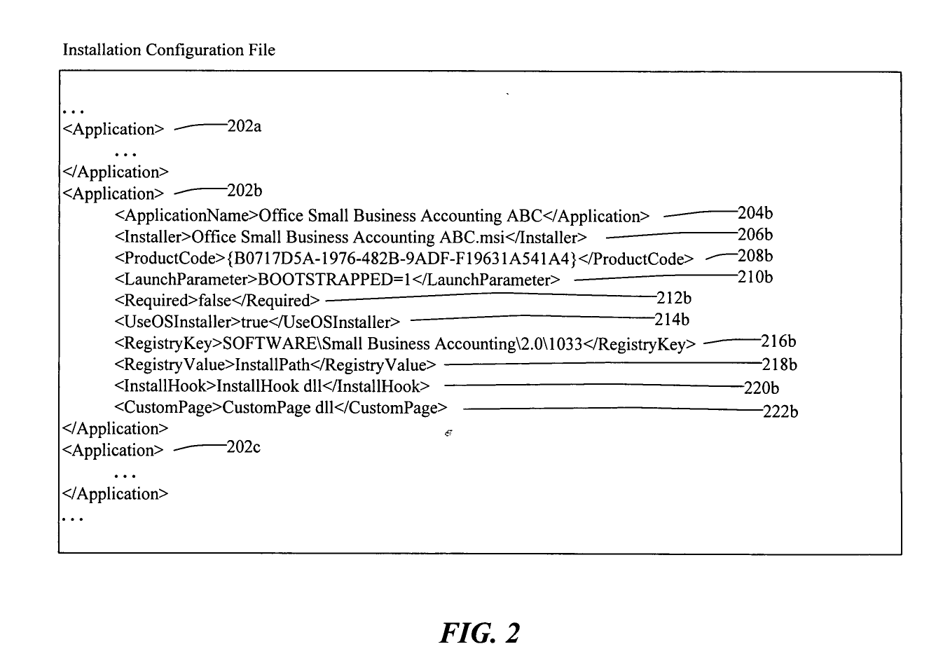

FIG. 2 illustrates selected contents of an example installation configuration file, according to some embodiments. In particular, the installation configuration file is implemented using XML. As depicted in FIG. 2, the installation configuration file comprises a plurality of application elements, for example, application elements 202a-c. Each of the application elements is an entry (e.g., record) for a software application that is identified in the installation configuration file and available for installation, for example, as part of an application suite to which the installation configuration file belongs. Each application element contains information about its corresponding software application.

By way of example and as illustrated in FIG. 2, application element 202b comprises an application name element 204b, an installer element 206b, a product code element 208b, a launch parameter element 210b, a required element 212b, a use OS installer element 214b, a registry key element 216b, a registry value element 218b, an install hook element 220b, and a custom page element 222b. The application name element contains the name of the software application that is displayed in the various dialogs (e.g., pages) to the user during the installation of the software application. The installer element specifies a relative path to an installation program to use in installing the software application. The installer element may specify a relative path to a generic installation program that is typically provided with an OS, such as an installation program provided with MICROSOFT WINDOWS (e.g., WINDOWS Installer MSI), or an application-specific installation program. The product code element specifies a product code for the software application. The launch parameter element specifies a specific parameter or parameters to use when the application suite installer program launches the installation program that is specified in the installer element. The required element specifies a Boolean value that indicates whether the software application is required to be installed on the computer system. The use OS installer element specifies a Boolean value that indicates whether the software application provides its own application-specific installation program that is to be used instead of the generic installation program that is provided with the OS executing on the computer system. For example, if the use OS installer element indicates that the software application provides its own installation program, the relative path to this installation program is specified in the installer element. The registry key element specifies a registry key that can be used to determine if the software application is already installed on the computer system. For example, when the software application is installed on the computer system, the specified registry key is placed in a registry, such as a product registry, on the computer system. This enables the application suite install program to look for the registry key in the product registry to determine whether the software application is installed on the computer system. The registry value element specifies a variable that indicates the location on the computer system where the software application is installed. The install hook element specifies a relative path to the assembly that implements the install hook interface. For example, the assembly may be an “InstallHook dll” that is provided by the software application. The InstallHook dll may implement a specific interface that is known by the application suite install program, thus allowing the application suite install program to call the methods and/or properties, such as, by way of example, a prerequisites method, a preinstall method, and a postinstall method, which are specified in the InstallHook dll. The custom page element may also specify a relative path to a “CustomPage dll” that is provided by the software application and which implements an interface that is known by the application suite install program. The application suite install program can call the method that is specified in the CustomPage dll to return a custom page for the software application.

One skilled in the art will appreciate that one or more of the elements described above may be optional and not contained in an application element. For example, an application element for a software application that does not use a custom page during its installation may not specify a custom page element. One skilled in the art will also appreciate that an application element can specify information other than the elements described above. For example, an application element for a software application that is provided through a web service may include an element that specifies a URL of the web server from where the software application can be obtained (e.g., downloaded).

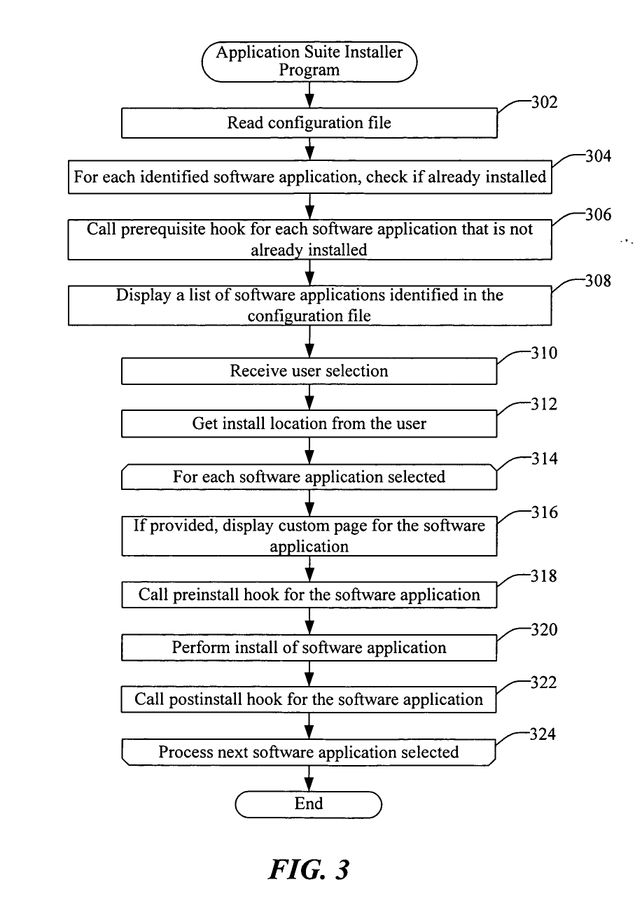

FIG. 3 is a flow diagram that illustrates the processing of an application suite installer program, according to some embodiments. By way of example, a user may have inserted a CD-ROM for an application suite into a CD drive on the user's computer system. The CD-ROM may contain an application suite installer program for the products in the application suite, an installation configuration file that contains information regarding the products in the application suite, and the application suite program files. In block 302, the application suite installer program starts running on the computer system and reads the installation configuration file to identify the software applications that are contained on the CD-ROM. In block 304, for each identified software application, the application suite installer program checks to determine if the software application is already installed on the computer system. For example, the application suite installer program can use the information in the registry key element and the registry value element for each of the identified software applications to determine if it is already installed on the computer system.

In block 306, the application suite installer program calls the prerequisite hook for each identified software application that is not already installed on the computer system. By performing calling the prerequisite hook for each software application, the application suite installer program is able to determine if the computer system is able to function as a host or platform for the software application. In block 308, the application suite installer program displays a list of the software applications that are identified in the installation configuration file to the user. Within the displayed list, the application suite installer program may “gray out” the software applications that are already installed or not capable of being installed, for example, because of the failure of the computer system to have the necessary prerequisites, on the computer system. The user is then able to select one or more of the software applications in the displayed list, except for the software applications that are grayed out, for installation on the computer system. For example, the user may be able to select a software application by “checking” or selecting a box provided next to the name or other identifier of the software application using an input device, such as a mouse. The application suite installer program can also prohibit the user form deselecting the software applications that are required to be installed.

In block 310, the application suite installer program receives the user's selection of the software applications that are to be installed on the computer system. In block 312, the application suite installer program gets the install location from the user. For example, the application suite installer program may display a page that requests the user to specify a location on the computer system where the software application is to be installed. For each software application selected for installation by the user (block 314), the application suite installer program performs blocks 316 to 322, until all of the selected software applications have been processed (block 324). In block 316, the application suite installer program displays to the user a custom page or pages that are provided for the software application. For example, the custom page may request the user to provide information or respond to queries that are specific to the software application. In block 318, the application suite installer program calls the preinstall hook for the software application. For example, the preinstall hook may perform actions on the computer system to prepare the computer system for installation of the software application. In block 320, the application suite installer program performs the install of the software application. The application suite installer program installs the software application by invoking the application installer specified in the installer element. In block 322, the application suite installer program calls the postinstall hook for the software application. For example, the postinstall hook may perform actions to configure and ready the installed software application for use by the user.

In some embodiments, the application suite install program can pass the user input received via a custom page to the preinstall hook, the post install hook, or both. For example, a custom page may ask the user whether a previous version of the software application should be uninstalled. If the user responds “yes” to this question, the application suite install program can send the user's response to the preinstall hook, and the preinstall hook can then uninstall the previous version of the software application. The information can be passed as a Boolean value or as part of a more detailed interaction between the application suite install program and the specified hooks.

One skilled in the art will appreciate that the prerequisite hook, preinstall hook, or post install hook may not perform any actions on the computer system. In these instances, the hooks may simply return to the calling program such as, for example, the application suite installer program.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps.

In some embodiments, the application suite installer program installs the selected software applications in the order listed in the installation configuration file. In these embodiments, the application developer needs to appropriately order the software applications in the installation configuration file. For example, if an application A needs to be installed prior to installing an application B on a computer system, then the entry for application A needs to be specified before the entry for application B in the installation configuration file. In other embodiments, the application suite installer program may include the logic to determine the order in which the software applications identified in the installation configuration file should be installed on a computer system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method in a computer system for installing one or more software applications in an application suite onto the computer system, the method comprising:
under control of an application suite installer program executing on the computer system,
reading an installation configuration file that is separate from the application installer program, the installation configuration file identifying one or more software applications available for installation on the computer system; and
based on the contents read from the installation configuration file, displaying on a page a list of software applications that are available for installation,
such that one or more of the software applications in the list can be selected for installation on the computer system.

2. The method of claim 1 further comprising:
under control of the application suite installer program executing on the computer system,
upon determining that one of the software applications displayed in the list of software applications is to be installed on the computer system,
identifying from the installation configuration file contents an application installer to use in installing the determined one of the software applications; and
installing the determined one of the software applications using the identified application installer.

3. The method of claim 1 further comprising:
under control of the application suite installer program executing on the computer system,
checking to determine whether any of the one or more software applications available for installation on the computer system are already installed on the computer system; and
indicating which of the applications programs in the list of software applications are already installed on the computer system,
such that the software applications in the list of software applications which are indicated as being already installed cannot be selected for installation on the computer system.

4. The method of claim 1 further comprising:
under control of the application suite installer program executing on the computer system,
for at least one of the identified software applications available for installation on the computer system,
identifying from the installation configuration file contents a prerequisite logic corresponding to the at least one of the identified software applications;
performing a prerequisite check of the computer system based on the identified prerequisite logic; and
upon determining that the prerequisite check is unsuccessful, indicating in the list of software applications that the at least one of the identified software applications cannot be selected for installation on the computer system.

5. The method of claim 1 further comprising:
under control of the application suite installer program executing on the computer system,
upon determining that one of the software applications displayed in the list of software applications is to be installed on the computer system,
identifying from the installation configuration file contents a custom page to display during the installation of the determined one of the software applications; and
displaying the identified custom page during the installation of the determined one of the software applications on the computer system.

6. The method of claim 1 further comprising:
under control of the application suite installer program executing on the computer system,
upon determining that one of the software applications displayed in the list of software applications is to be installed on the computer system,
identifying from the installation configuration file contents a preinstall logic corresponding to the determined one of the software applications; and
performing a preinstall operation on the computer system based on the identified preinstall logic prior to installing the determined one of the software applications.

7. The method of claim 1 further comprising:
under control of the application suite installer program executing on the computer system,
upon determining that one of the software applications displayed in the list of software applications is to be installed on the computer system,
identifying from the installation configuration file contents a postinstall logic corresponding to the determined one of the software applications; and
performing a postinstall operation on the computer system based on the identified postinstall logic subsequent to installing the determined one of the software applications.

8. The method of claim 1 further comprising:
under control of the application suite installer program executing on the computer system,
upon determining that one of the software applications displayed in the list of software applications is to be installed on the computer system,
identifying from the installation configuration file contents a required component that needs to be installed with the determined one of the software applications; and
installing the identified required component along with the determined one of the software applications.

9. The method of claim 1, wherein the installation configuration file is provided on a removable storage media.

10. The method of claim 1, wherein the installation configuration file is provided on a web server.

11. The method of claim 1, wherein the installation configuration file is an XML file.

12. One or more computer memories collectively containing an installation configuration file that identifies one or more software applications, the installation configuration file comprising, for at least one application program identified in the installation configuration file, information that identifies the supported application program and information that identifies an installation program to use in installing the supported application program,
such that the contents of the installation configuration file may be used by an installation wizard to present the identified software applications for selection by a user for installation on a computer system.

13. The computer memories of claim 12, wherein the installation configuration file comprises, for at least one application program identified in the installation configuration file, a registry key corresponding to the identified application program, the registry key to be used by the installation wizard to determine if the identified application program is already installed on the computer system.

14. The computer memories of claim 12, wherein the installation configuration file comprises, for at least one application program identified in the installation configuration file, information that identifies a location where the identified application program was installed on the computer system.

15. The computer memories of claim 12, wherein the installation configuration file comprises, for at least one application program identified in the installation configuration file, a relative path to an application installer that is to be used by the installation wizard to install the identified application program on the computer system.

16. The computer memories of claim 15, wherein the installation configuration file comprises, for at least one application program identified in the installation configuration file, one or more application installer-specific parameters that is to be used by the installation wizard when launching the application installer.

17. The computer memories of claim 12, wherein the installation configuration file comprises, for at least one application program identified in the installation configuration file, information indicating whether the identified application program is required to be installed on the computer system.

18. The computer memories of claim 12, wherein the installation configuration file comprises, for at least one application program identified in the installation configuration file, information that identifies specialized code that is to be used by the installation wizard to install the identified application program on the computer system.

19. An application suite installer system comprising:
an installation configuration file comprising information that identifies one or more software applications, and for at least one application program identified in the installation configuration file, information that identifies the supported application program and information that identifies an installation program to use in installing the supported application program; and
an application suite installer program that is separate from the installation configuration file, the application suite installer program configured to,
determine from the contents of the installation the software applications identified in the installation configuration file;
display on a page a list of the software applications identified in the installation configuration file; and
upon receiving an indication to install one or more of the software applications in the list of software applications, install the indicated one or more software applications.

20. The system of claim 19, wherein the application suite installer program is configured to install each of the indicated one or more software applications using a respective installation program, each of the respective installation programs being identified in the installation configuration file.
